(19) United States
(12) Patent Application Publication
(10) Pub. No.: US 2021/0260709 A1
(43) Pub. Date: Aug. 26, 2021

(54) DEVICE FOR MACHINING WORKPIECES

(71) Applicant: SAUTER FEINMECHANIK GMBH, Metzingen (DE)

(72) Inventors: Markus KOTZUR, Amberg (DE); Markus FEDER, Riederich (DE)

(21) Appl. No.: 17/270,932

(22) PCT Filed: Aug. 27, 2019
(86) PCT No.: PCT/EP2019/072749

§ 371 Date: Feb. 24, 2021

(30) Foreign Application Priority Data
Aug. 31, 2018 (DE) 10 2018 006 928.2

(51) Int. Cl. B23Q 5/06; B23Q 5/26

(52) U.S. Cl. CPC B23Q 5/06; B23Q 5/261

(57) ABSTRACT

1. Device for machining

2. The invention relates to a device for machining workpieces, preferably provided for use with a handling system, consisting of at least one rotary drive unit (26), which is guided in a device housing (2) in a longitudinally movable manner and which rotatably drives a cutting tool (100), and having a feed drive unit (32, 60), which moves the rotary drive unit (26) from a rear non-working position into a front working position and vice versa.

The invention relates to a device for machining workpieces, preferably intended for use with a handling system. More specifically, the invention is directed at a machining device intended for use with handling systems in the form of industrial robots having a program-controlled working unit on the cantilever of a robot arm.

The use of tooling on robot arms of industrial robots is state of the art in industrial manufacturing and is used with different kinds of tooling for a wide variety of machining and handling tasks. By way of example, DE 10 2013 206 791 A1 shows a working unit in the form of a so-called robot hand on the arm cantilever of the robot arm of an industrial robot.

Based on this state of the art, the invention addresses the problem of providing a device of the type mentioned at the beginning which, while of a simple and compact construction, can be used particularly advantageously in conjunction with handling systems, such as industrial robots, for machining by means of rotating tools.

According to the invention, this problem is solved by a device having the features of claim 1 in its entirety.

Accordingly, the invention provides at least one rotary drive unit, which is guided in a device housing in a longitudinally movable manner and which rotatably drives a cutting tool, and a feed drive unit, which moves the rotary drive unit from a rear non-working position to a front working position and vice versa. Because both the rotary drive for a rotary tool, such as a drill, and the drive for the feed motion are combined in one device housing, whereby the device housing simultaneously forms the longitudinal guide for the rotary drive unit, all the functional units required for machining operations, such as drilling operations, are available in one unit. The device according to the invention can therefore be used with particular advantage as a working unit that operates autonomously with regard to both drive units and feed guidance, on a handling system such as the robot arm of an industrial robot.

In advantageous exemplary embodiments, the rotary drive unit has a motor housing, which, guided in a longitudinally movable manner in the device housing by a guide device, is coupled to the feed drive unit on its end facing the latter, and is penetrated at least on its other opposite end by a drive shaft, to which the machining tool can be attached.

Advantageously, the feed drive unit can have a control chamber, in which a control piston is pneumatically guided in a movable manner from the non-working position to the working position against the force of an energy accumulator and is attached to a control rod of the feed unit, the free end of which engages with the motor housing of the rotary drive unit.

The rotary drive unit may have a pneumatic motor, the operating medium, air, of which is supplied via the control rod. The design of both drives as pneumatic drives provides the advantageous opportunity of providing the entire energy supply for the device through a single supply unit, such as a compressed air source.

Advantageously, the arrangement can be such that buffer devices are provided in the control chamber, which are used as stops for the control piston in its end positions. In this way, an end stop for the tool feed, such as limiting the drilling depth of a relevant drilling tool, can be implemented.

In advantageous exemplary embodiments, the other free end of the control rod extends out of the device housing and contacts a damper device, which preferably acts on the control rod in both opposite directions of travel.

To control the feed motion adapted to the machining task, a sensor device can be used to monitor the position of the other free end of the control rod, which extends out of the device housing. Advantageously, an inductive sensor device can be provided here based on one or more proximity switches.

In this respect, the arrangement can advantageously be made in such a way that the other free end of the control rod extending out is connected to a control plate, with which the damper device engages, wherein at least one of the end positions of the control plate is monitored by means of the sensor device.

In particularly advantageous exemplary embodiments, the control rod for guiding the pneumatic medium of the pneumatic motor is hollow and is permanently connected via a transverse connection to an annular chamber in the device housing, wherein said annular chamber in turn is connected to a compressed air supply line in the device housing, wherein the overall length of the annular chamber permits at least a partially overlap with the transvers connection in any travel position of the control rod. Because the control rod not only performs the feed function and guide function but also supplies pressure to the pneumatic motor, the device housing can be formed having a particularly compact form.

A drill chuck can be arranged at the free end of the drive shaft, wherein said drill chuck is used to hold a drill as a cutting tool.

At its free end, the drill can pass through a guide device which, guided past the outer circumference of the drill chuck, has at its free end a centering aid for placing the device on the workpiece, preferably having the form of a sheet metal plate or another sheet metal blank. The guide device can be formed as a type of drill sleeve, which has a conical taper at the front outlet end, wherein said conical taper forms a slight indentation when the device is pressed against the relevant sheet metal part with a pressing force, wherein said indentation helps to attach the drill center to the workpiece. Depending on the requirement, however, a centering is not mandatory; then the guide device remains at a distance from the workpiece to be drilled and is used exclusively to guide the drilling tool during drilling.

The invention is explained in detail below, with reference to an exemplary embodiment shown in the drawing. In the Figures:

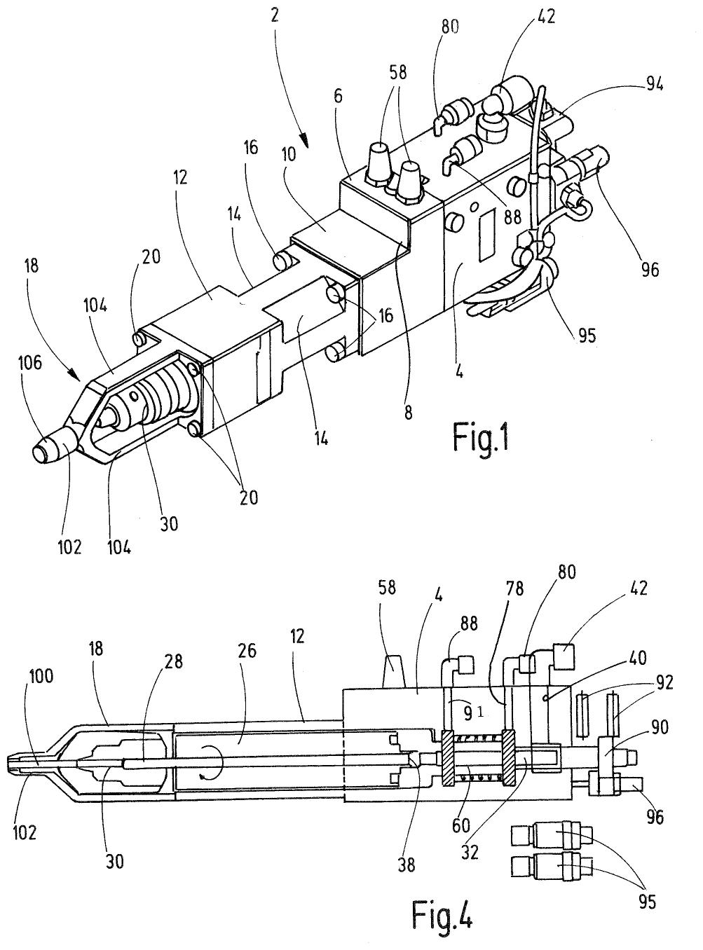

FIG. 1 shows a perspective oblique view of the exemplary embodiment of the device according to the invention;

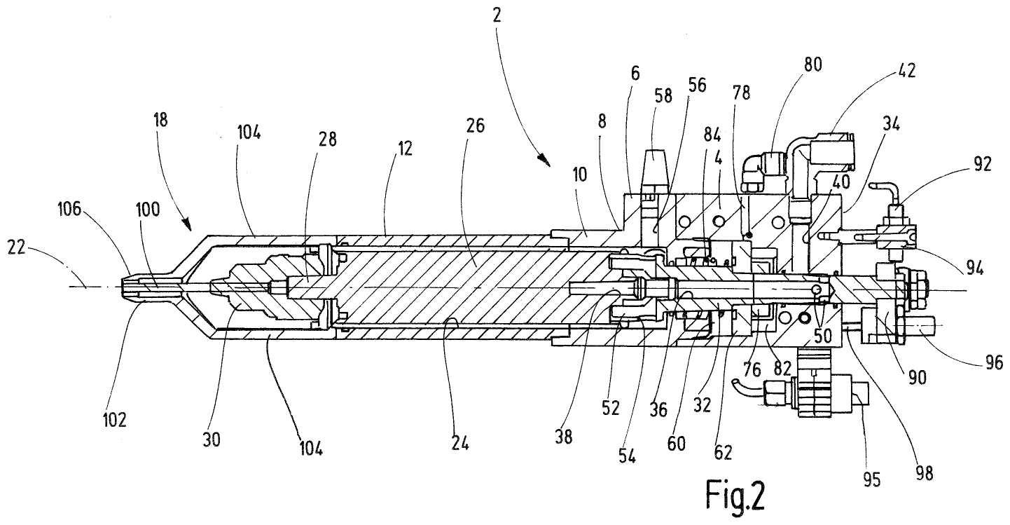

FIG. 2 shows a longitudinal section of the exemplary embodiment of the device according to the invention;

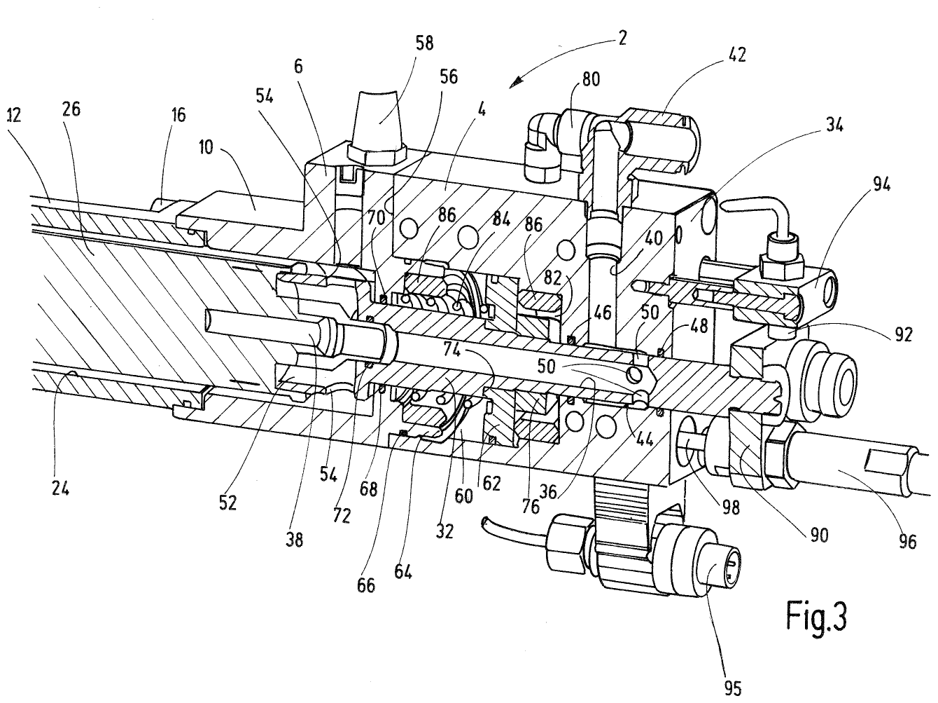

FIG. 3 shows a perspective oblique view, cut off and sectioned in the central vertical plane, of the housing section, comprising the feed drive unit, of the exemplary embodiment; and

FIG. 4 shows a simplified functional sketch of the exemplary embodiment.

As can be seen most clearly from FIG. 1, the exemplary embodiment, shown in the drawing, of the device according to the invention has a device housing designated as a whole by 2, which has a main housing part 4 having a rectangular cross-section, adjoined by a housing attachment 6, which at a step 8 merges into a housing extension 10 having a reduced outline and a square cross-section. To the housing extension 10 a front housing part 12 is attached, which has the same outline as the square housing extension 10, but which has wall recesses 14 in its outer wall area facing the extension 10, wherein said wall recesses 14 form free spaces for fastening bolts 16, which are used to flange the front housing part 12 to the housing extension 10. To the front free end of the front housing part 12 in turn adjoins a guide device 18, which is flanged to the front housing part 12 by means of fastening bolts 20.

As shown in FIGS. 2 and 3, the circular cylindrical interior, concentric to the longitudinal axis 22 of the device, of the front housing part 12 and the adjoining housing extension 10 form a longitudinal guide 24 for the motor housing 26 of a pneumatic motor. Its drive shaft 28, which, see FIG. 2, exits from the motor housing 26 at the end of the front housing part 12, is connected to a drill chuck 30, which can be used in the usual manner to clamp a rotary tool, such as a drill 100. The other end of the motor housing 26, which extends inside the longitudinal guide 24 into the area of the housing extension 10, is firmly connected to a control rod 32 which, coaxial with the axis 22, extends through the housing attachment 6 and the main housing part 4 and projects outwards beyond the housing end 34 located on the right in FIGS. 2 and 3. The control rod 32 is part of the pneumatic feed drive unit, which is located inside the main housing part 4, and also forms a line section for the compressed air supply of the pneumatic motor located in the motor housing 26.

For this purpose, the control rod 32 has an inner supply channel 36 coaxial with the axis 22, wherein the left end (in FIGS. 2 and 3) of said inner supply channel 36 is connected to a compressed air inlet 38 of the motor housing 26. A supply line 40, extending to the top of the housing, is formed in the main housing section 4 for supplying compressed air to the channel 36 of the control rod 32, wherein said supply line 40 is supplied via a compressed air port 42 located on the top of the housing. The inner end of the supply line 40 opens into an annular chamber 44, which, as FIG. 3 shows, encompasses the control rod 32 in an area located between sealing elements 46 and 48. At the inner end of the channel 36, the latter is connected to the annular chamber 44 via transverse holes 50. The axial length of the annular chamber 44 is selected such that both in the non-working position shown in the figures and in the pushed forward working positions, the transverse bores 50 overlap the annular chamber 44 and, as a result, also in these positions the pneumatic motor can be supplied with compressed air from the supply line 40 via the channel 36. As FIG. 3 most clearly shows, the control rod 32 has a bell-shaped extension in the area where it is connected to the motor housing 26, wherein said bell-shaped extension forms an outflow chamber 52 for the air flow returning from the pneumatic motor, wherein from said outflow chamber 52 the returning air passes via outflow ducts (only one of which is visible in FIG. 3) to silencers 58, which form the air outlet on the top of the housing.

The feed drive unit, which is also pneumatically actuated and whose feed force is transmitted to the motor housing 26 via the control rod 32, has a control chamber 60, in which a control piston 62 is guided. The control chamber 60 in the main housing part 4 is formed by a circular cylinder, coaxial with the axis 22 and located in the main housing part 4, wherein the open end, facing the housing attachment 6, of said circular cylinder is closed by the housing attachment 6, a projecting collar 64 of which extends into the interior of the cylinder, wherein a gasket 66 forms the seal. Further sealing rings 70 and 72 form the seal between the control rod 32 and the housing attachment 6 and between the control rod 32 and the compressed air inlet 38 on the motor housing 26, respectively, see FIG. 3. The control piston 62 abuts a step 74 located on the outer circumference of the control rod 32 to transmit the feed force to the control rod 32, wherein a nut 76 located on an external thread of the control rod 32 holds the piston 62 in contact with the step 74 (FIG. 3).

As can be seen only in FIGS. 2 and 4, a supply channel 78, running in the main housing part 4, for the pneumatic actuation of the control piston 62 is formed, wherein said supply channel can be supplied from a further compressed air port 80 located on the top of the housing, to lead compressed air to a pressure chamber 82, which is formed by a cylinder of reduced internal diameter adjoining the control chamber 60. A compression spring 84 is supported on the piston side, facing the pressure chamber 82, of the control piston 62, wherein the other end of said compression spring 84 rests against the housing attachment 6 forming the closure of the control chamber 60. The feed drive unit is completed by buffer devices arranged in the control chamber 60, against which the control piston 62 abuts in the end positions of its working motions. The buffer devices are each formed by an annular body 86, each of which abuts one of the ends of the control chamber 60. A throttle check valve 88 is provided for venting the control chamber 60 on the piston end of the control piston 62, wherein said control chamber 60 is opposite the pressure chamber 82 and in which the compression spring 84 is located, wherein said throttle check valve 88 is connected to the part, facing away from the pressure chamber 82, of the control chamber 60 via a venting channel 91 (FIG. 4).

The end, routed out of the end 34 of the main housing part 4, of the control rod 32 is connected to a control plate 90, which is part of a sensor device for monitoring the axial position of the control rod 36. The sensing device has at least one proximity switch 92 attached to a holder 94 at a defined distance from the housing end 34. In this regard, FIGS. 2 and 3 show the arrangement of only one proximity switch 92, whereas FIG. 4 shows the arrangement of two proximity switches 92. Connectors 95 are used to connect the respective proximity switches 92 to the control electronics of the device. Having a plate part projecting from the control rod 32 on the end opposite from the respective proximity switches 92, the control plate 90 also forms the holder for at least one shock absorber 96, the piston rod 98 of which rests against the main housing part 4 and has a damping effect on the control rod 32 in both directions of travel. Two shock absorbers can also be provided, one damping during extension and the other during retraction.

The exemplary embodiment shown in the drawings is formed for a tool in the form of the drill bit 100 clamped in the drill head 30. When performing the drilling operation, the guide device 18 has a centering aid in the form of a drill sleeve 102, which is held, coaxial with the longitudinal axis 22, by two retaining brackets 104 of the guide device 18 at a distance in front of the drill chuck 30. The retaining brackets 104 extend forward opposed to each other and spaced apart from the drill chuck 30 towards the sleeve 102 . At its free end, the sleeve 102 is tapered by an end cone 106. To perform a drilling operation, the device is moved to the workpiece to be drilled, such as a sheet metal panel, at a predeterminable distance, by the concerning handling system.

When the supply of compressed air via the port 42 has set the pneumatic motor in motion, the drill 100 is fed forward because of the compressed air supply of the pressure chamber 82 at the control piston 62, wherein the feed motion is monitored by the sensor device. During the motion of the control piston 62, which because of its contact with the step 64 of the control rod 36 entrains the latter and causes the feed motion of the motor housing 26 in the longitudinal guide 24 in conjunction with the drill chuck 30, the control piston 62 moves against the restoring force of the compression spring 84. In so doing, the space, containing the compression spring 84, of the control chamber 60 is vented via the throttle check valve 88. After the drilling process has been completed and the pressure supplies via the ports 42 and 80 have been terminated, the compression spring 84 resets the control piston 62, which is no longer pressurized, while now the pneumatic motor is at a standstill, such that the drill head 30 and the motor housing 26 together with the control rod 32 reverse against the feed direction. Additionally, or alternatively to a spring-loaded return of the control piston 62, however, it can also be returned by pneumatic compressive force. There, the throttle check valve 88 provides throttled ventilation of the space of the control chamber 60 containing the compression spring 84. When the pneumatic motor is set in motion and the compressed air exits through the discharge ducts 56, the silencers 58 reduce the operating noise of the drilling operation.

1. A device for machining workpieces, preferably provided for use with a handling system, consisting of at least one rotary drive unit (26), which is guided in a device housing (2) in a longitudinally movable manner and which rotatably drives a cutting tool (100), and having a feed drive unit (32, 60), which moves the rotary drive unit (26) from a rear non-working position into a front working position and vice versa.

2. The device according to claim 1, characterized in that the rotary drive unit has a motor housing (26), which, guided in a longitudinally movable manner in the device housing (2) via a guide device (24), is coupled to the feed drive unit (32, 60) at its end facing the latter and is passed through at least at its other opposite end by a drive shaft (28), on which the machining tool (100) can be fixed.

3. The device according to claim 1, characterized in that the feed drive unit has a control chamber (60), in which a control piston (62) is pneumatically guided in a movable manner from the non-working position to the working position against the force of an energy storage (84) and is attached to a control rod (32) of the feed unit (32, 60), the free end of which acts on the motor housing (26) of the rotary drive unit.

4. The device according to claim 1, characterized in that the rotary drive unit (26) has a pneumatic motor, the operating medium, air, of which is supplied via the control rod (32).

5. The device according to claim 1, characterized in that buffer devices (86) are provided in the control chamber (60), which are used as stops for the control piston (62) in its end positions.

6. The device according to claim 1, characterized in that the other free end of the control rod (32) extends out of the device housing (2) and contacts a damper device (96), which preferably acts on the control rod (32) in both opposite directions of travel.

7. The device according to claim 1, characterized in that a sensor device (90, 92) is used to monitor the position of the other free end of the control rod (32).

8. The device according to claim 1, characterized in that the other free end of the control rod (32) is connected to a control plate (90), on which the damper device (96) acts, and in that at least one of the end positions of the control plate (90) is monitored by means of the sensor device (92).

9. The device according to claim 1, characterized in that the control rod (32) for guiding the pneumatic medium of the pneumatic motor is hollow and is permanently connected via a transverse connection (50) to an annular chamber (44) in the device housing (2), wherein said annular chamber (44) in turn is connected to a compressed air supply line (40) in the device housing (2), and in that the overall length of the annular chamber (44) in any travel position of the control rod (32) permits at least a partial overlap with the transverse connection (50).

10. The device according to claim 1, characterized in that a drill chuck (30) is arranged at the free end of the drive shaft (28), wherein said drill chuck (30) is used to hold a drill (100) as a cutting tool.

11. The device according to claim 1, characterized in that at its free end, the drill (100) passes through a guide device (18), which, guided past the outer circumference of the drill chuck (30), has at its free end a centering aid (102, 106), which is used to guide the drill (100) during machining.
